(19) United States
(12) Patent Application Publication
(10) Pub. No.: US 2008/0087787 A1
(43) Pub. Date: Apr. 17, 2008

(54) Apparatus for overhead storage

(76) Inventor: Michael Baumer, Penfield, NY (US)

Correspondence Address: HOWARD J. GREENWALD P.C., 349 W. COMMERCIAL STREET SUITE 3075, EAST ROCHESTER, NY, 14445-2408, US

(21) Appl. No.: 11/973,544

(22) Filed: Oct. 9, 2007

Related U.S. Application Data
(60) Provisional application No. 60/851,941, filed on Oct. 16, 2006.

(51) Int. Cl. A47G 29/02; F16M 13/00

(52) U.S. Cl. 248/324; 248/343

(57) ABSTRACT

An apparatus for overhead storage that contains an adjustable horizontal support and at least two vertical adjustment mechanisms attached to two vertical supports. The vertical adjusting mechanisms are comprised of an arm and a latching mechanism, with an angle between the arm and the latch mechanism of from about 90 to about 175 degrees.

This patent application claims priority based upon applicants' provisional patent application 60/851,941 filed on Oct. 16, 2006. This invention relates generally to a support structure for overhead storage that can be mounted on a wall, ceiling, spaced panels, or over an existing bar.

### FIELD OF THE INVENTION

### BACKGROUND OF THE INVENTION

Safely storing items in an overhead storage area has been a longstanding problem in the art. The prior art is replete with examples of attempts to solve such storage problems, but to date, none has proven entirely satisfactory.

U.S. Pat. No. 5,199,843 to Sferra (Overhead Storage System) describes a complex lift system for storing articles in a garage. Unfortunately, the device of Sferra is too complex for everyday use. A need still exists for affordable overhead storage systems.

U.S. Pat. No. 5,402,979 to Bellamy (Overhead Storage Apparatus) teaches an adjustable overhead storage apparatus that can accommodate articles of various lengths. While such an apparatus is more affordable than that disclosed by Sferra, the user of the Bellamy device must lift the article overhead to attach it to the device. For heavy articles, the user may be unable to lift such an article. Moreover, an article that is disposed overhead may fall upon the user of the device. Such an accident could subject an employer or home owner to liability. It would be advantageous to provide an overhead storage apparatus that could avoid such accidents.

U.S. Pat. No. 5,474,189 to Peterson (Bicycle Lift and Storage System) describes a bicycle storage apparatus that allows the user to load a bicycle onto the apparatus and thereafter lift the bicycle into an overhead position. While such a device may avoid accidentally dropping the bicycle, the device is complex and expensive. Such a device is also difficult to adapt to store articles other than bicycles. A similar storage device is illustrated in U.S. Pat. No. 6,095,344 to White (Overhead Storage System).

U.S. Pat. No. 6,361,022 to Lob (Lifting Device) depicts a device for lifting watercraft. The device of Lob may be adapted to lift other elongated objects, but is not able to lift smaller objects.

Additional overhead storage devices are also known in the art. Reference may be had to U.S. Pat. No. 5,649,751 to Longhurst (Structural Member Supported Storage Unit); U.S. Pat. No. 5,667,035 to Hughes (Overhead Platform Elevation Device); U.S. Pat. No. 5,725,293 to Wilkening (Overhead Storage Unit); U.S. Pat. No. 5,871,070 to Contreras (Overhead Storage Lift Assembly); U.S. Pat. No. 5,897,104 to Garbiso (Overhead Hoist and Sling Apparatus for Removing, Storing, and Replacing a Removable Automobile Hardtop); U.S. Pat. No. 6,135,528 to Sobieski (Combined Storage Compartment and Garage Door Opening Transmitter Storage and Actuating Compartment); U.S. Pat. No. 6,145,678 to Morrison (Adjustable, Suspended Overhead Storage Rack); U.S. Pat. No. 6,155,440 to Arce (Ceiling-Mounted Storage Bracket); U.S. Pat. No. 6,241,048 to Heilmann (Storage Platform and Lift Apparatus); U.S. Pat. Nos. 6,354,682; 6,357,842; and 6,550,878 to Nott (Overhead Storage Device); U.S. Pat. No. 6,725,608 to Kraus (Garage Overhead Storage Assembly); U.S. Pat. No. 6,851,376 to D'Agostino (Pull Down Shelf for Overhead Storage); and U.S. Pat. No. 6,938,940 to Lipke (Overhead Storage Assembly). The content of each of the aforementioned patents is hereby incorporated by reference into this specification.

It is an object of this invention to provide a simple, inexpensive overhead storage apparatus that permits the user to safely lift an article into an overhead storage position.

### SUMMARY OF THE INVENTION

In accordance with one embodiment of the present invention, there is provided an apparatus for overhead storage that is comprised of an adjustable horizontal support and at least two vertical adjustment mechanisms attached to two vertical supports. The vertical adjusting mechanisms are comprised of an arm and a latching mechanism, with an angle between the arm and the latch mechanism of from about 90 to about 175 degrees.

### BRIEF DESCRIPTION OF THE DRAWINGS

The invention will be described by reference to the following drawings, in which like numerals refer to like elements, and in which:

FIG. 1 is a front view of one preferred storage apparatus;

FIG. 2 is a partial front view of one side of the storage apparatus of FIG. 1;

FIG. 3 is a side view of the vertical adjusting mechanism of the storage apparatus depicted in FIGS. 1 and 2;

FIG. 4 is a more detailed view of the mechanism of FIG. 3;

FIG. 5 is an illustration of the mechanism of FIG. 3 in its latched configuration;

FIGS. 6A and FIG. 6B are depictions of the pivotable nature of the mechanism of FIG. 2;

FIGS. 7A and FIG. 7B illustrate mounts for use with the present invention;

FIGS. 8A and FIG. 8B depict attachments for use with the present invention;

FIGS. 9A and FIG. 9B show two uses for the present invention;

FIGS. 10A and 10B illustrate strap storage devices for use with the instant invention;

FIG. 11 illustrates another preferred storage assembly;

FIG. 12 illustrates the assembly of FIG. 11 in its latched position; and

FIG. 13 illustrates additional mounting devices that may be used with the device of this invention.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENTS

For a general understanding of the present invention, reference is made to the drawings. In the drawings, like reference numerals have been used throughout to designate identical elements.

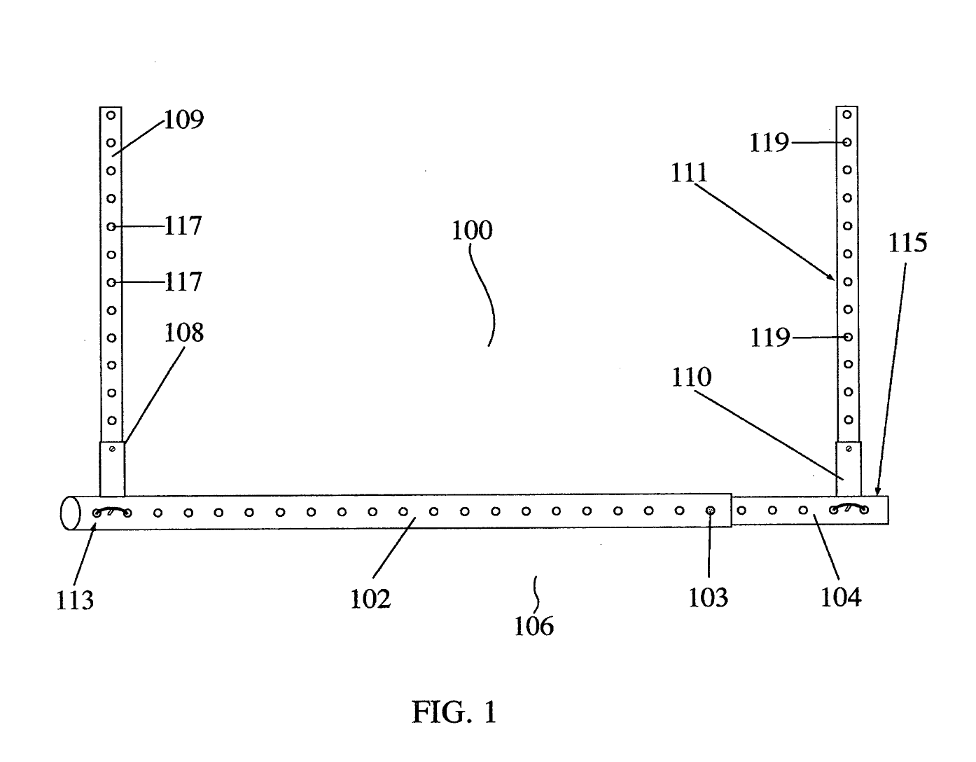

FIG. 1 is a depiction of overhead storage apparatus 100. Apparatus 100 is comprised of horizontal support assembly 106 that is comprised of a horizontal support 102 and a horizontal support 104. The apparatus 100 is also comprised of a first vertical adjusting mechanism 108 and a second vertical adjusting mechanism 110. The first vertical adjusting mechanism 108 is connected to a vertical support 109; and the second vertical adjusting mechanism 110 and vertical support 111.

Referring again to FIG. 1, horizontal support assembly 106 is comprised of outer support 102 (also referred to as horizontal support 102) and inner support 104 (also referred to as horizontal support 104).

The length of assembly 106 is adjustable, depending upon the position of inner support 104 within outer support 102. Once the desired position of inner support 104 vis-à-vis outer support 102 has been obtained, one may removably lock these supports 102/104 into place by use of a locking means such as, e.g., a spring-loaded tab, a nut and bolt assembly, etc.).

Outer support 102 and inner support 104 are hollow rails that may have a circular cross-sectional shape, a square cross-sectional shape, a rectangular cross-sectional shape, a triangular cross-sectional shape, etc. In the preferred embodiment depicted in FIG. 1, outer support 102 and inner support 104 are hollow cylinders configured such that inner support 104 is disposed within outer support 102 and can slide freely within such outer support 102. Thus, the length of horizontal support 106 is adjustable along its horizontal axis. In one embodiment, the length of horizontal support 106 is adjustable from a length of from about 1 meter to about 2 meters. When the length has been adjusted to its desired value, the length may be locked by a locking mechanism 103.

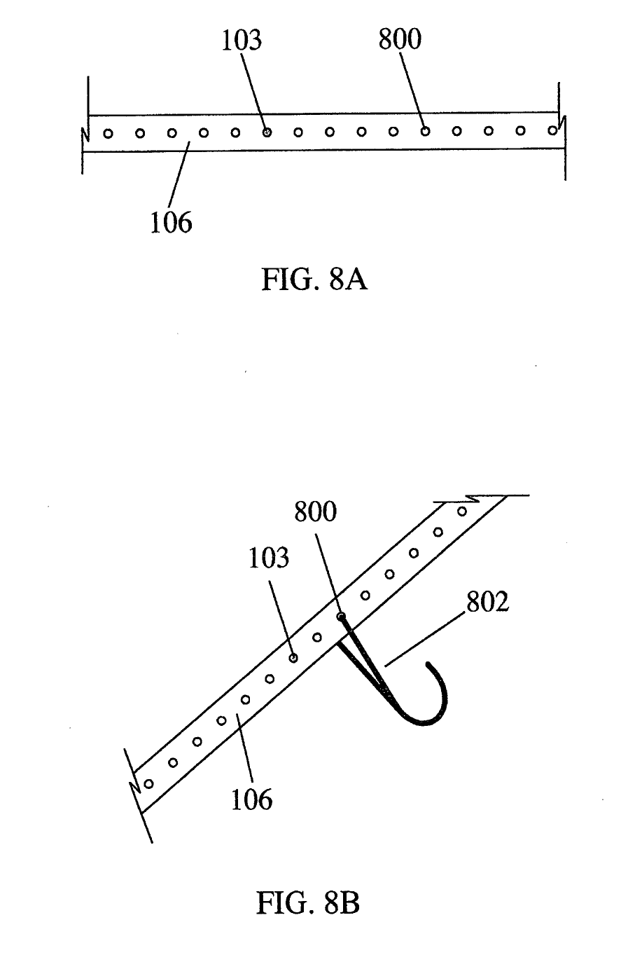

In one embodiment, the locking mechanism is a spring loaded tap (not shown) disposed on inner support 104 that fits through opening 800 (see FIG. 8) in outer support 102. Such spring loaded taps are well known in the art. In another embodiment, the locking mechanism is a simple nut-bolt assembly (not shown) that fits through opening 800 in both inner support 104 and outer support 102.

Referring again to FIG. 1, and in the preferred embodiment depicted, there are two vertical adjusting mechanisms, mechanisms 108 and 110.

The first vertical adjusting mechanism 108 is located at the proximal end 113 of horizontal support 106 and the second vertical adjusting mechanism 110 is located at the distal end 115 of horizontal support 106. The vertical adjusting mechanisms 108/110 are fixedly attached to the horizontal support 106. The vertical supports 109/111 are each attached to their respective vertical adjusting mechanism 108/110 in a preferred manner that will be described in detail elsewhere in this specification.

In the preferred embodiment depicted in FIG. 1, each of the vertical supports 109 and 111 is a strap 109/111 that is comprised of a multiplicity of orifices 117 and 119, respectively. In one embodiment, the strap 109/111 is made out of nylon strapping, and the orifices 117 and 119 are reinforced holes. These and similar straps are well known to those skilled in the art. Reference may be had, e.g., to U.S. Pat. No. 3,960,302 (ski carrying strap), U.S. Pat. No. 4,221,029 (binding strap fastener), U.S. Pat. No. 4,239,271 (loop for flexible strap), U.S. Pat. No. 4,832,393 (moving/lifting device with a strap), U.S. Pat. No. 5,058,243 (strap connector), U.S. Pat. No. 5,107,995 (strap for holding a surfboard), U.S. Pat. No. 6,044,528 (strap retainer), U.S. Pat. No. 6,138,327 (flexible strap arrangement), U.S. Pat. No. 6,322,483 (adjustable strap device), and the like. The entire disclosure of each of these U.S. patents is hereby incorporated by reference into this specification.

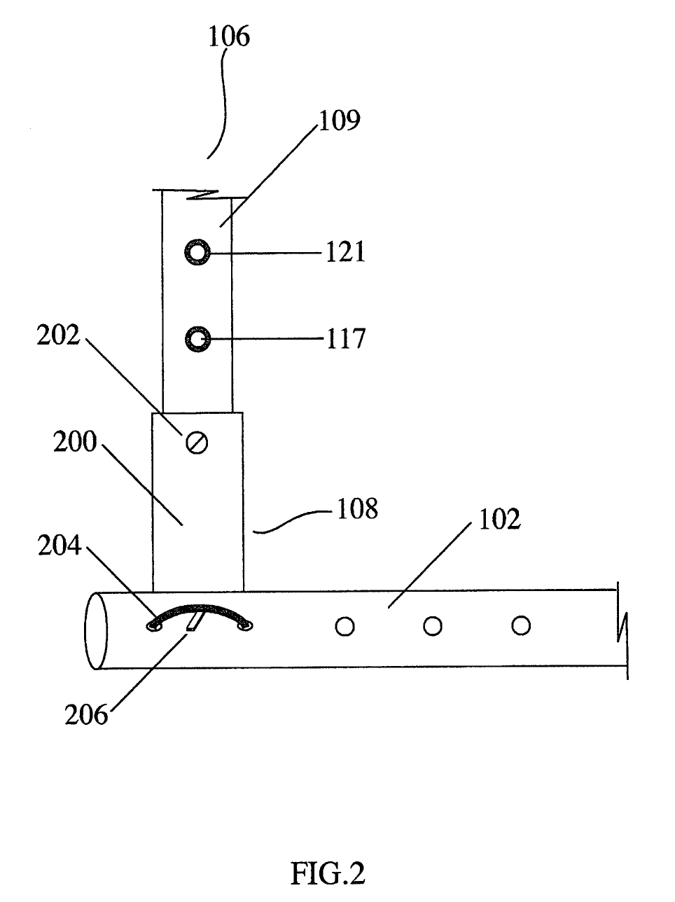

In one preferred straps 109 and 111 are made from nylon strapping; and the orifices 117/119 within such straps are preferably reinforced with suitable reinforcing means such as, e.g., a grommet (not shown in FIG. 1, but see element 121 of FIG. 2) or an eyelet (not shown).

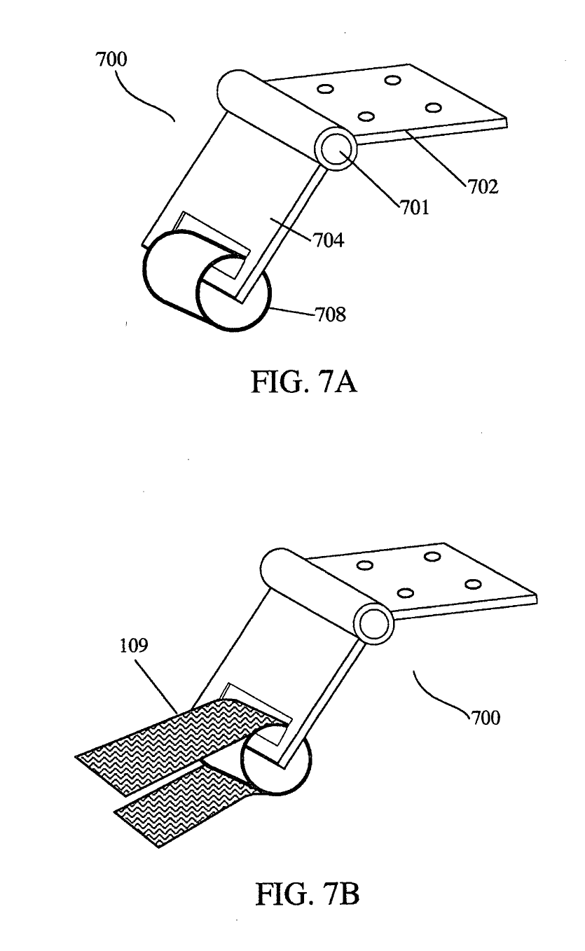

Referring again to FIG. 1, the straps 109 and 11 are preferably configured to pass through an overhead mount (not shown in FIG. 1, but see FIG. 7) that is fixedly attached to an overhead fixture, such as a ceiling or overhead beam. By operating the vertical supports 109/111, the user can adjust the height of the horizontal support 106 and raise or lower such support 106 to a desired location. For example, the user may lower the support, place a bicycle upon the horizontal support, and thereafter raise the support—thus securely storing the bicycle in an overhead location.

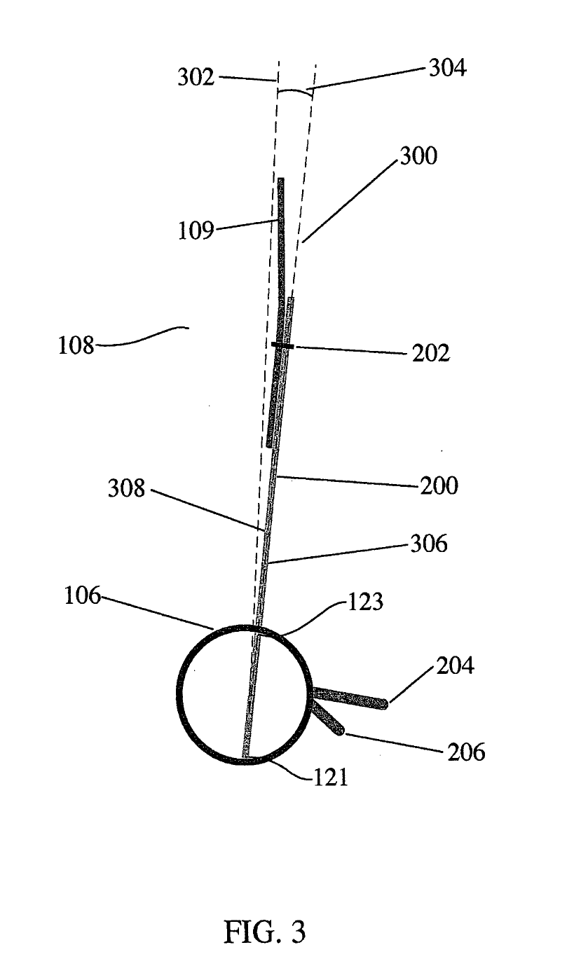

FIG. 2 is a partial front view of assembly 100; and FIG. 3 is a side view of such assembly 100. Referring to the preferred embodiment depicted in FIGS. 2 and 3, vertical adjusting mechanism 108 is comprised of arm 200, that is attached to horizontal support 106 and, in particular, to horizontal support 102. As is illustrated in FIG. 3, the arm 200 extends through support 102 and is attached to the interior portion of support 102 at points 121 and 123. Such attachment may be effectuated by conventional means such as, e.g., epoxy adhesive, welding, etc.

Referring again to FIGS. 2 and 3, and the preferred embodiment depicted therein, it will be seen that a guide 204 is attached to the horizontal assembly 106. As will be clearly seen from FIG. 2, such guide 204 is adapted to receive the strap 109.

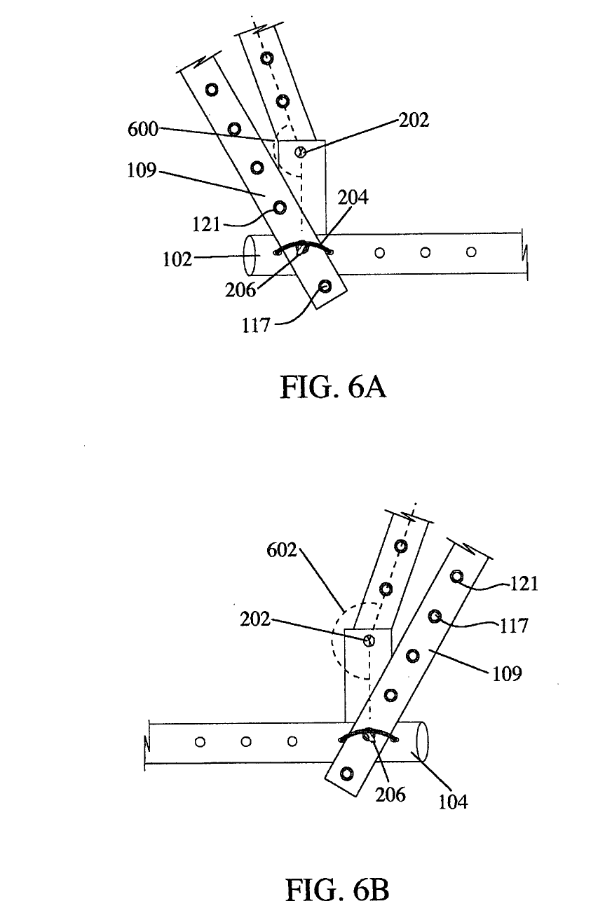

Referring to FIG. 2, a latching mechanism 206 is shown attached to support 102. As is illustrated in FIG. 6A, the latching mechanism 206 is adapted to protrude through orifice 117 that, preferably, is reinforced by a grommet 121. Such latching mechanism 206 also is illustrated in FIG. 3, where it is shown being attached to the support 106/102.

In one embodiment, and referring again to FIG. 2, arm 200 has a height of from about 3 centimeters to about 15 centimeters. In another embodiment, arm 200 is from about 6 to about 11 centimeters long. In yet another embodiment, arm 200 is from about 8 to about 10 centimeters long.

Without wishing to be bound to any particular theory, applicant believes that arm 200 helps to ensure that the horizontal support 102 does not roll when the vertical support 109 is adjusted. For example, in those embodiments where arm 200 is not present, raising support 102 by adjusting vertical supports 109/111 may cause the support 106 to roll. Such rolling causes the vertical support 109/111 to become unlatched from the assembly 206. Arm 200 acts as a lever that prevents such rotation of horizontal support 106.

Also shown in FIG. 2 for clarity of illustration is outer support 102 (to which vertical adjusting mechanism 108 is attached) and vertical support 109. Vertical support 109 attaches to arm 200 at pivot point 202.

Certain novel features of vertical adjusting mechanisms 108/110 are illustrated in FIGS. 3, 4, and 5.

FIG. 3 shows vertical adjusting mechanism 106 in its unlatched configuration. As shown in FIG. 3, arm 200 has a first side 306 and a second side 308, which is opposite first side 306. Latching mechanism 206 protrudes from horizontal support 106 on the same side as first side 306. Vertical support 109 attaches to arm 200 on second side 308. It is therefore apparent that vertical support 109 and latching mechanism 206 are preferably disposed on opposite sides of arm 200. Such a configuration causes arm 200 (and thus latching mechanism 206) to obtain a certain arm angle 304. In another embodiment (not shown), vertical support 109 attaches to first side 306 and thus vertical support 109 is on the same side of arm 200 as latching mechanism 206. As previously discussed, arm 200 has a length which promotes such a configuration. Additionally, the weight and relative position of guide 204 also helps to obtain such a configuration. Arm angle 304 is defined as the angle between a line 300 that is drawn through arm 200 and a line 302 that passes substantially through vertical support 109. When the apparatus is freely hanging, line 302 is substantially perpendicular to the ground.

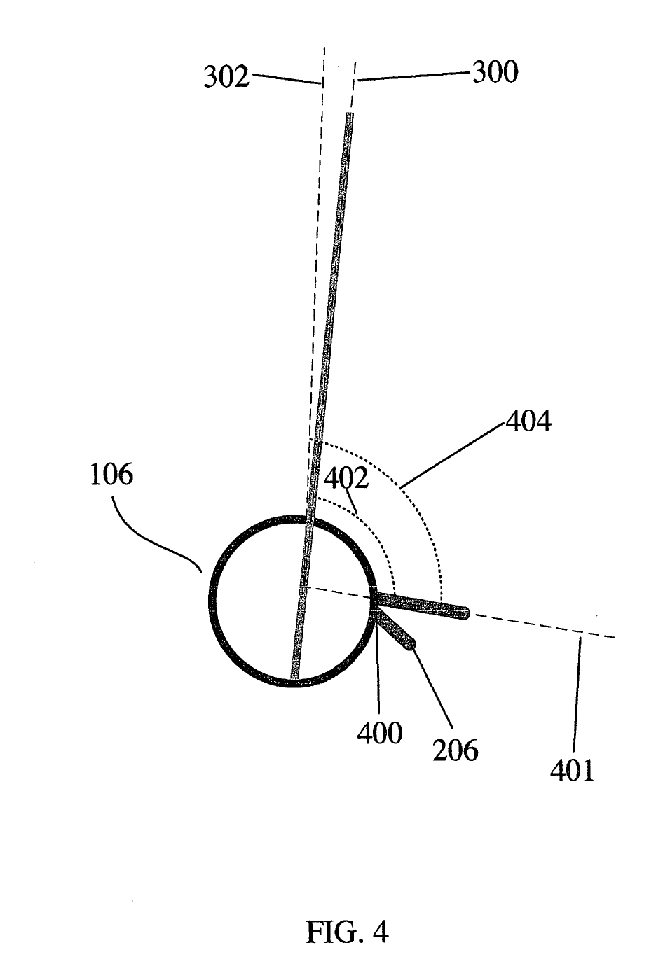

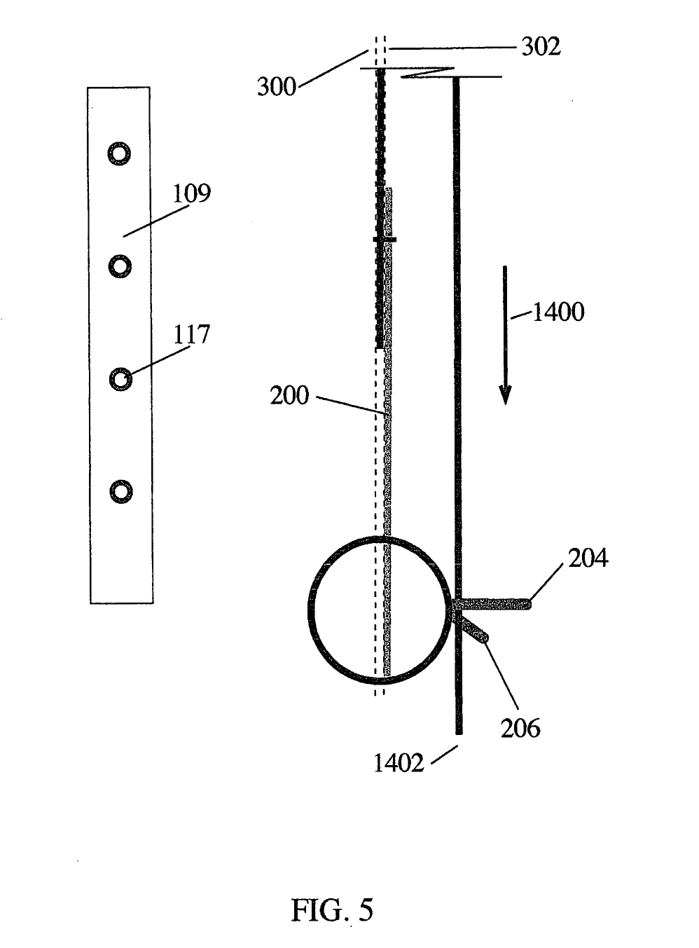

FIG. 4 is another illustration of vertical adjusting mechanism 108 in its unlatched configuration. FIG. 4 shows certain angles that are relevant to the operation of mechanism 108. Line 302 is vertical with respect to the ground. Line 300 passes through arm 200. Point 400 is the point where latching mechanism 206 protrudes from horizontal support 106 (see FIG. 1). Latch line 401 passes through point 400 and intersects with arm line 300. Angle 402 is the angle between the latching line 401 and the arm line 300. In the embodiment depicted, angle 402 is about 90 degrees. Angle 404 is the angle between the latching mechanism 206 and the vertical line 302. In another embodiment, the angle 402 is from about 95 to about 175 degrees; in one aspect of this embodiment, such angle is from about 92 to about 120 degrees. In another embodiment, the angle 402 is from about 100 to about 170 degrees. In yet another embodiment, the angle 402 is from about 130 to about 150 degrees. In the unlatched configuration angle 404 is greater than angle 402 (i.e. the latching mechanism 206 is “leaning forward”). Angle 404 and angle 402 have substantially the same magnitude when the latching mechanism 206 is in its latched configuration. Such a configuration is illustrated in FIG. 5.

FIG. 5 is an illustration of apparatus 100 (see FIG. 1) in its latched configuration. Also illustrated in FIG. 5 is vertical support 109, which is comprised of latch receivers 117. In the embodiment depicted, latch receivers 117 are a plurality of holes/orifices that are reinforced with, e.g., with metal rings, grommets 121 (see FIG. 2), eyelets, etc. Vertical support 109 preferably passes through overhead mounts (not shown in FIG. 5, but see FIG. 7) and back through guide 204 (see FIG. 2). Latching mechanism 206 engages latch receiver 117 and thus holds horizontal support 106 (see FIG. 1) at a predetermined height. When the latching mechanism 206 is thus engaged, the vertical adjustment mechanism 108 rotates such that lines 300 and 302 become substantially parallel. In other words, angle 402 and angle 404 become substantially equal. Such a configuration allows the vertical support 109 to be securely fastened to latching mechanism 206. The angle 402 (see FIG. 4) further promotes such a secure attachment as does the “leaning forward” of latching mechanism 206 that is described elsewhere in this specification. In the embodiment depicted, latching mechanism 206 is preferably shaped like a peg. In another embodiment, not shown, latching mechanism 206 is shaped like a downwardly pointing hook. Such a hook ensures that the vertical support 109 will not accidentally slip.

FIGS. 6A and 6B illustrate the pivot point 202 of apparatus 100. In some embodiments, it is not always possible to mount overhead mounts (see FIG. 7) directly above vertical adjustment mechanisms 108/110. In such an embodiment, it is advantageous that the apparatus 100 be able to easily pivot vertical supports 109/11 as the horizontal support 106 is raised and/or lowered.

Pivot point 202 also permits the user to raise the horizontal support 106 asymmetrically. As used in this specification, the term “asymmetrical configuration” refers to a state wherein the proximal end 113 and the distal end 115 are at different heights. Likewise, the term “symmetrical configuration” refers to a state wherein the proximal end 113 and the distal end 115 are at substantially the same height. Such an asymmetrical raising of support 106 is advantageous because it is often difficult for a user to operate both vertical adjusting mechanisms 108/110 simultaneously. For example, and with reference to FIG. 1, the user may operate the vertical adjusting mechanism 108 that is located on the distal end 113 and thereby raise distal end 113 above proximal end 115. Advantageously, pivot point 200 permits vertical supports 109/111 to pivot at both the proximal end 113 and distal end 115 independently to accommodate the asymmetrical configuration. Thereafter, the user may operate the vertical adjusting mechanism 108 that is located on the proximal end 113 and thereby raise the proximal end 113 to be at the same height as distal end 115. Once both sides have been adjusted, the apparatus is once again symmetrical. In some embodiments, the user leaves the apparatus in an asymmetrical configuration.

Referring again to FIG. 5, it will be seen that, when a force is applied to vertical support 111 in the direction of arrow 1400 (such as, e.g., by pulling on the end 1402 of the vertical support 111), vertical support 111 will tend to release itself from locking mechanism 206. In particular, such application of force will tend to cause vertical support 111 to slide off of locking mechanism 206. Thus, and as will be apparent, the device depicted in FIG. 5 has comprises a ready means for unlocking the vertical support 111, thereafter adjusting its length, and thereafter again removably locking it to the mechanism 206.

In the embodiment depicted in FIG. 6A, the overhead mounts (not shown) are spaced further apart than the vertical adjustment mechanisms 108/110. As such, angle 600 is generally between about 90 degrees and about 180 degrees. As the horizontal support 106 is raised, it becomes closer to the overhead mounts and angle 600 gradually decreases.

In the embodiment depicted in FIG. 6B, the overhead mounts (not shown) are spaced closer together than the vertical adjustment mechanisms 108/110. As such, angle 602 is generally from about 180 degrees to about 270 degrees. As the horizontal support 106 is raised, it becomes closer to the overhead mounts and angle 600 gradually increases.

To help promote a smooth motion, overhead mounts are used in certain embodiments of the present invention; these overhead mounts are preferably adapted to receive straps 109 and/or 111.

One such overhead mount is illustrated in FIG. 7. Referring to FIG. 7, overhead mount 700 is preferably comprised of fixed plate 702 that is configured to be securely attached to a structure such as a ceiling or overhead beam. Mount 700 is further comprised of hanging plate 704 joined to fix plate 702 with hinge 701. Disposed on hanging plate 704 is slide 708. Slide 708 is configured to allow vertical support to easily side over its surface. In the embodiment depicted, slide 708 freely rotates. In another embodiment (not shown) the slide 708 is non-rotatable, but the low friction surface permits the vertical support 108 (see FIG. 7B) to slide over its surface. FIG. 7B is a depiction of vertical support 108 disposed on slide 708.

FIGS. 8A and 8B illustrate the use of attachment 802, which permits the user of the apparatus 100 the hang a wide variety of items. Attachment 802 is configured to be inserted into opening 800. As would be appreciated by one skilled in the art, a variety of attachments may be used. In the embodiment depicted, attachment 802 is a simple hook. Such a hook may be used, for example, to mount a bicycle to the apparatus.

In the embodiment depicted in FIG. 8B, attachment 802 is configured to pivot about opening 800. Such a pivotable attachment is particularly well suited for embodiments where the apparatus is in (or temporarily goes through) an asymmetrical configuration. For example, when distal end 113 is raised above proximal end 115, the horizontal support 106 is no longer parallel to the ground. However, the pivotable attachment (such as attachment 802) pivots to ensure the articles remain securely attached to such attachment 802.

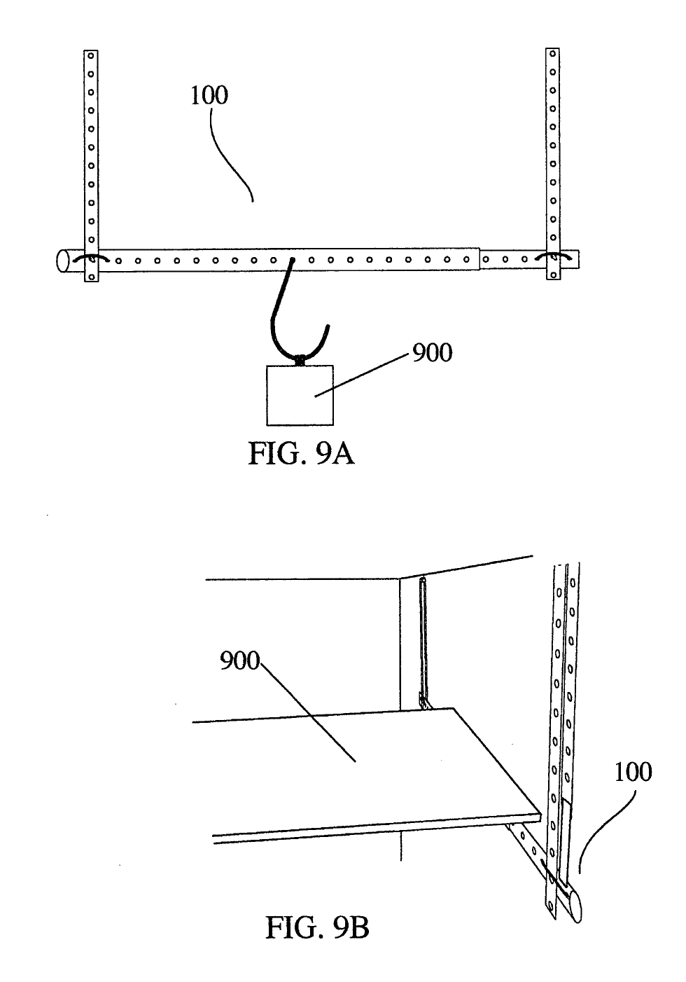

FIG. 9A is a depiction of the apparatus in use. In the embodiment depicted, apparatus 100 is used to store article 900.

In another embodiment, not shown, two devices 100 are used in conjunction with one another and attachment 802 is a strap designed to bridge the two devices. In the embodiment depicted, only one apparatus 100 is shown, but the position of the second apparatus will be evident from inspection of the figure. By operating the two devices in unison, a large object, such as a boat, can be lifted by the straps. In yet another embodiment, two devices are used and attachment 800 is a shelf 900 (see FIG. 9B) disposed between the two devices. Operation of the two devices allows the user to raise and lower the shelf. Articles, such as holiday decorations, may be placed on the shelf for seasonal or long term storage. Clearly, the device of the present invention can accommodate a wide variety of articles and attachments. Such adaptability makes the present apparatus a significant improvement over the prior art.

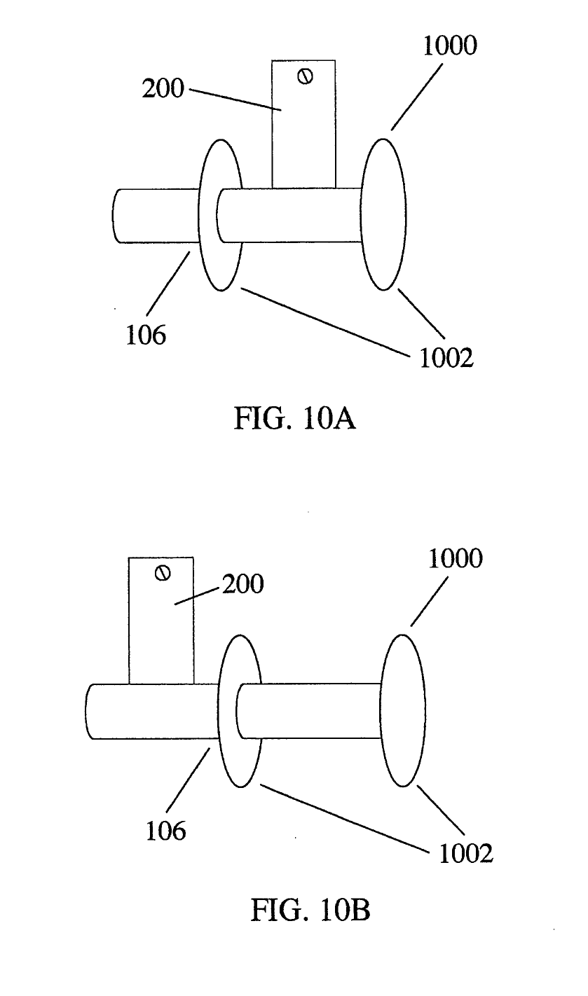

FIGS. 10A and 10B show optional strap storage 1000. In the embodiment depicted, strap storage 1000 is disposed on one of the ends of horizontal support 106. In another embodiment, one such strap storage device is present on each end of horizontal support 109. Strap storage 1000 is comprised of edges 1002 that help to keep the vertical support 109 (see FIG. 1) in a secure position when the apparatus 100 is not in use. For example, when the device is not in use, vertical support 109 may be wrapped around strap storage 1000 such that support 109 rests between edges 1002. In FIG. 10B, the storage device 1000 is shown as being adjacent to arm 200. In another embodiment, the storage device is superimposed atop arm 200 (see FIG. 10A).

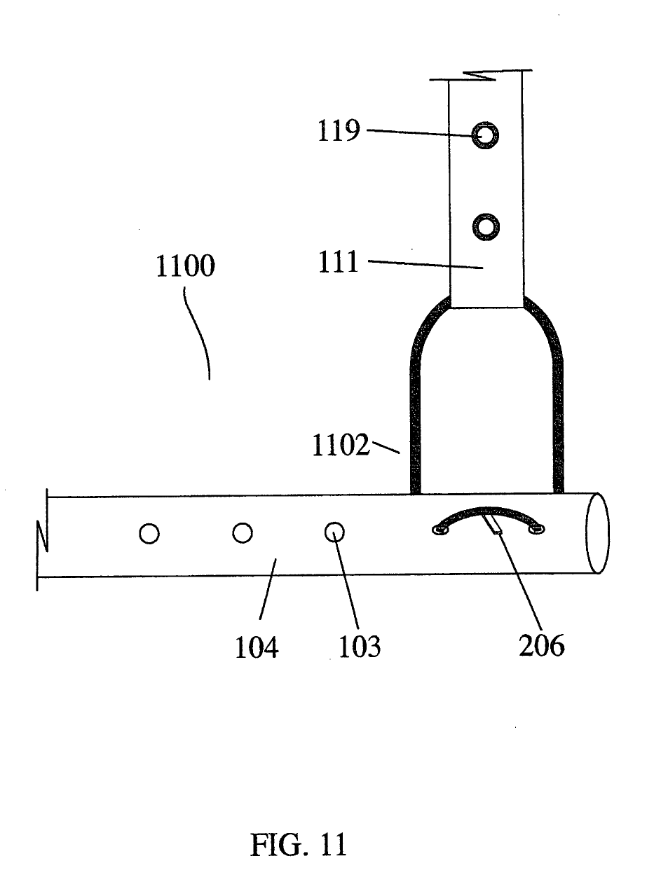

FIG. 11 is a schematic of a storage device 1100 that is comprised of a vertical adjusting mechanism 1102 that is similar in some respects to the mechanisms 108/110 depicted, e.g., in FIG. 1 but is comprised of a U-shaped rod 1102 that, in one embodiment, is a U-bolt. The U-shaped rod 1102 is preferably connected to the horizontal support 106 (see FIG. 1). In one embodiment, such connection is substantially permanent.

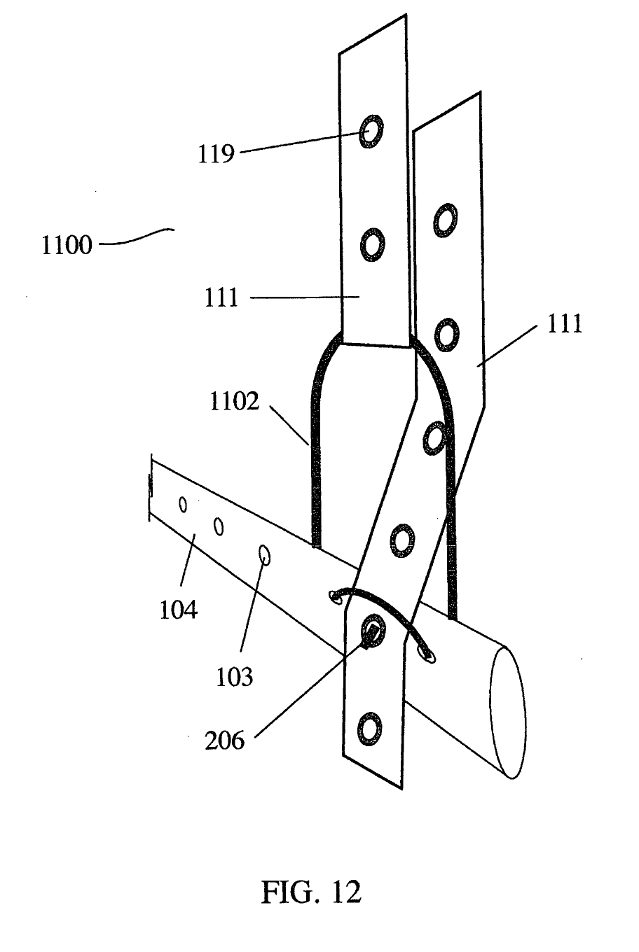

FIG. 12 is a schematic of storage device 1100 showing such device in its latched configuration.

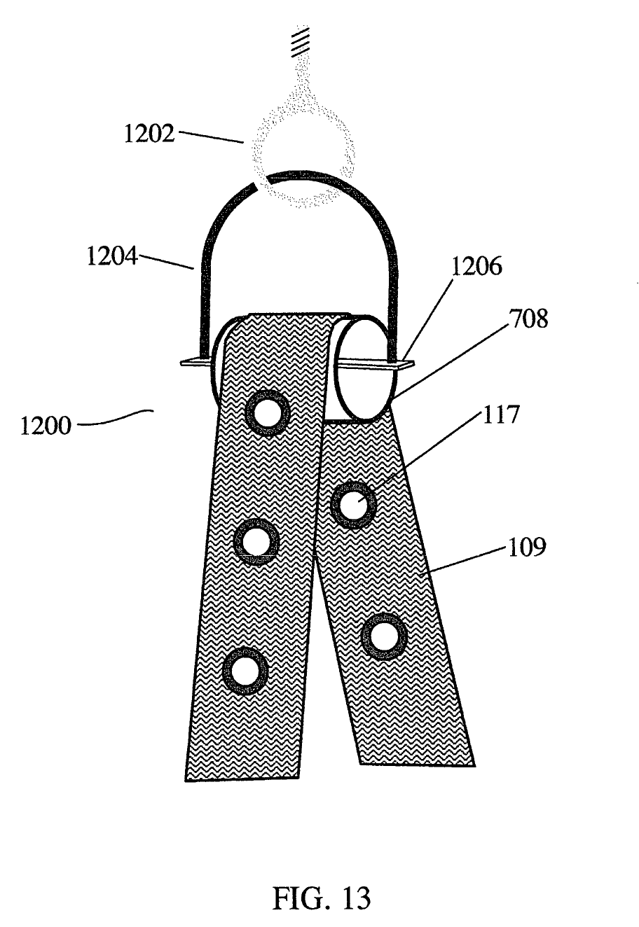

FIG. 13 is a schematic of a device 1200 that is similar to the device 700 (see FIGS. 7A and 7B) but differs therefrom in that it comprises an eyescrew 1202 connected to a U-bolt 1204. The U-bolt 1204 is connected to a support 1206 that, in turn, is connected to slide 708. In one embodiment, slide 708 is fixedly mounted to support 1206; in another embodiment, slide 704 is rotatably mounted to support 1206.

It is therefore apparent that there has been provided, in accordance with the present invention, an apparatus for overhead storage. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

I claim:

1. An apparatus for overhead storage comprised of an adjustable horizontal support, a first vertical adjustment mechanism, a second vertical adjustment mechanism, a first vertical support attached to said first vertical adjustment mechanism, a second vertical support attached to said second vertical adjustment mechanism, wherein:
(a) said first vertical adjustment mechanism is comprised of a first arm and a a first latching mechanism, wherein said first arm is connected to said first latching mechanism and forms an angle therewith of from about 90 to about 175 degrees, and
(b) said second vertical adjustment mechanism is comprised of a second arm and a second latching mechanism, wherein said first arm is connected to said first latching mechanism and forms an angle therewith of from about 90 to about 175 degrees.

2. The apparatus as recited in claim 1, wherein said first arm forms an angle with respect to said first latching mechanism of from about 92 to about 120 degrees.

3. The apparatus as recited in claim 2, wherein said second arm forms an angle with respect to said second latching mechanism of from about 92 to about 120 degrees.

4. The apparatus as recited in claim 3, wherein said apparatus is comprised of means for removably locking said first vertical support onto said first latching mechanism.

5. The apparatus as recited in claim 4, wherein said apparatus is comprised of means for removably locking said second vertical support from said second latching mechanism.

6. The apparatus as recited in claim 5, wherein said apparatus is comprised of means for unlocking said first vertical support from said first latching mechanism.

7. The apparatus as recited in claim 6, wherein said apparatus is comprised of means for unlocking said second vertical support from said second latching mechanism.

8. The apparatus as recited in claim 7, wherein said first vertical support is pivotally attached to said first vertical adjustment mechanism.

9. The apparatus as recited in claim 8, wherein said second vertical support is pivotally attached to said second vertical adjustment mechanism.

10. The apparatus as recited in claim 9, further comprising means for attaching an item to be stored that is attached said adjustable horizontal support.

11. The apparatus as recited in claim 10, wherein said means for attaching an item to be stored is pivotally connected to said adjustable horizontal support.

12. The apparatus as recited in claim 11, further comprising a mounting assembly connected to said first vertical support and said second vertical support.

13. The apparatus as recited in claim 12, wherein said mounting assembly is comprised of a first mount and a second mount.

14. The apparatus as recited in claim 13, wherein each of said first mount and said second mount is comprised of means for connecting said mount to a surface.

15. The apparatus as recited in claim 14, wherein said first mount is comprised of a first slot, and said first vertical support is movably disposed in said first slot

16. The apparatus as recited in claim 15, wherein said second mount is comprised of a second slot, and said second vertical support is movably disposed in said second slot
